(19) United States
(12) Patent Application Publication
(10) Pub. No.: US 2006/0260688 A1
(43) Pub. Date: Nov. 23, 2006

(54) Silt trap for water and gas valve boxes

(76) Inventor: John Bobby Green, Blountsville, AL (US)

Correspondence Address: Charles D. Gunter, Jr.;Whitaker, Chalk, Swindle & Sawyer, LLP, Suite 3500, 301 Commerce Street, Fort Worth, TX, 76102-4186, US

(21) Appl. No.: 11/436,083

(22) Filed: May 17, 2006

Related U.S. Application Data
(60) Provisional application No. 60/683,326, filed on May 23, 2005.

(51) Int. Cl. F16L 5/00

(52) U.S. Cl. 137/371

(57) ABSTRACT

A silt trap is shown which provides easy access to the end of a valve stem of a valve in a buried water main having a valve box which extends from the valve to the surface. The trap is a tapered bowl having a centrally located I-bolt for removal. The lip of the bowl is covered by a U-shaped gasket which seals around the entire periphery of the bowl lip. The device traps silt and other debris and can be easily removed for dumping without allowing debris to fall into the valve box.

### CROSS-REFERENCE TO RELATED APPLICATIONS

This application claims priority from a provisional application Ser. No. 60/683,326, filed May 23, 2005.

### BACKGROUND OF THE INVENTION

1. Field of the Invention

The present invention relates generally to underground access boxes containing underground valves, such as those being commonly employed in municipal water and gas systems utilizing lines that are buried underground.

2. Description of the Prior Art

When underground lines are laid, it is generally necessary to have one or more underground valves in the lines for use in controlling the flow of the material through the lines. For example, in the case of municipal water works distribution system, many miles of water lines are buried in the streets and right of ways in order to serve municipal customers. Included in these miles of pipelines there may be hundreds, if not thousands, of valves. These are typically gate valves to control the flow of water in the pipeline system. The valves are typically installed in pipelines that are buried, for example, from three to ten feet under the surface of the ground. The use of underground valves of this general type has necessitated the use of valve boxes to allow a means of obtaining access to the valves without having to dig down in the earth to uncover the valve.

Valve boxes of the type under consideration are well known in the relevant industries and are generally tubular casings which may have an enlarged lower bell housing that encompasses the valve. The upper end of the valve box generally includes a cover which is oftentimes located generally flush with the ground surface. By removing the cover or lid on the valve box, and by using a special tool, such as a T-handled socket wrench, a maintenance man can normally quickly gain access to the end of the valve stem of the buried valve and operate it to turn it on and off. This can be done provided that the enclosure, that is, the valve box, is not filled with silt, sand, road-base material, solidified material, or other debris which prevents access to the operating end of the valve stem.

As well-known in the prior art, when a water line becomes broken, very serious damage can result from water gushing out of the break and flooding adjacent residences or other buildings, doing substantial damage to the surrounding properties. In some cases, emergency crews have difficulty obtaining access to the operating stems of the valves because the valve box or enclosure has become filled up, as has been described. Typically, a good deal of difficulty is experienced in digging out or extracting debris from the underground enclosure which, in turn, delays the time before the emergency can be corrected, and the valve or valves are shut off to stop water coming out of the break.

The present invention has as one object to provide a simple and inexpensive means to prevent the buildup of silt or other debris in underground valve boxes, so that the valve stem located in such boxes is readily accessible at all times.

Another object of the invention is to provide such a device which fits most commercially available valve boxes of the type used in the water and gas distribution industries without the need to modify such valve boxes.

Another object of the invention is to provide such a device which will trap any sediment tending to fall in around a valve nut in a valve box, which device can be simply pulled out and emptied periodically and which will not allow sediment to fall inside the box during removal.

### SUMMARY OF THE INVENTION

A silt trap is shown for use with a valve box of an underground valve. The valve box has a valve-operating stem with an operating fitting at an operating end thereof. The valve box forms a circular enclosure with an interior defined by a lower region surrounding the operating end of the valve stem and an upper region extending to a surrounding surface. The silt trap comprises a trap body formed as a tapered bowl having an upper peripheral lip region and downwardly extending tapered sidewalls which terminate in a generally planar bottom region of the bowl. The peripheral lip region of the trap body is sized to have a predetermined diameter which allows it to be received on an internal shoulder provided within the upper region of the circular enclosure. The trap body also has a peripheral sealing element which circumscribes the upper peripheral lip region of the bowl and a centrally located handling element which extends upwardly from the bottom region of the bowl. The trap body can be installed within the interior of the circular enclosure of the valve box on an internal shoulder provided therein by lowering the trap body into position using the handling element. The peripheral sealing element forms a seal with the interior of the circular enclosure which prevents the enclosure from accumulating silt and debris.

In one preferred form of the invention, the tapered bowl is formed of stainless steel and the handling element is an I-bolt. A U-shaped gasket surrounds the peripheral lip region of the bowl when in place. This version of the device is sized to be received within the existing diameter of a 7 1/2 inch cast iron water or gas valve box.

In the method of the invention, assured access is provided to a valve-operating stem, having an operating fitting at an operating end thereof, of an underground valve. As previously described, the valve has a circular enclosure with an interior defined by a lower region surrounding the operating end of the valve stem and an upper region extending to a surrounding surface. In the first step of the method, a silt trap is provided which is sized to be received within the upper region of the circular enclosure, the silt trap being formed as a tapered bowl having an upper peripheral lip region and downwardly extending tapered sidewalls which terminate in a generally planar bottom region of the bowl. The silt trap also has a peripheral sealing element which circumscribes the upper peripheral lip region of the bowl and a centrally located handling element which extends upwardly from the bottom region of the bowl. The silt trap is installed by using the handling element to lower the trap into position on an internal shoulder provided within the interior of the circular enclosure, the upper peripheral lip region of the tapered bowl being appropriately sized so that peripheral sealing element which circumscribes the upper peripheral lip region forms a seal with the interior of the circular enclosure.

In the next step of the method of the invention, the silt trap is periodically removed from the enclosure by using the handling element to retrieve the trap from the interior of the enclosure. The trap can then be emptied of any accumulated silt or debris, followed by reinstalling the trap within the interior of the enclosure.

Additional objects, features and advantages will be apparent in the written description which follows.

### BRIEF DESCRIPTION OF THE DRAWINGS

FIG. 1 is partial, cross sectional view of a typical prior art underground pipeline installation showing a gate valve and valve box and illustrating the general environment of the present invention.

FIG. 2 is a side view of the silt trap of the invention showing a hidden portion of the handling element of the trap in dotted lines for ease of illustration.

FIG. 3 is a top view of the silt trap of FIG. 2.

FIG. 4 is side, partial cross sectional view illustrating, in exploded fashion, the installation of the silt trap of the invention on an internal shoulder provided within the valve box interior.

FIG. 5 is a view similar to FIG. 4, but showing the assembled silt trap within the valve box and with the valve box cover in place.

### DETAILED DESCRIPTION OF THE INVENTION

Underground valves of the type under consideration will be well familiar to those skilled in the relevant waterworks and natural gas industries. As has been briefly described, the invention deals with a device and method whereby access to the end of the valve stem at the bottom of the valve box may be more easily assured, as well as for preventing the buildup of silt, debris or other material in the bottom of the valve box with the passage of time.

Typically, a valve box of the type under consideration may have a size which is in the range of 6 inches to 12 inches in diameter, depending upon the size of the water main and valve with which it is operated. In one embodiment, the silt trap of the present invention is designed to fit a standard 7½ inch cast iron water and gas valve box. However, it will be readily appreciated that the device of the invention can be provided in convenient sizes to fit all standard valve boxes, both water and gas. Typically, the valve in question, such as a gate valve, has an operating stem at the end of which is an operating fitting, typically in the form of a square nut which can receive a square socket at the end of the operating tool, which extends to the surface. From the foregoing, it is to be seen that the tool, as described, can be inserted into the valve box, and then by rotating, the valve can be opened or closed.

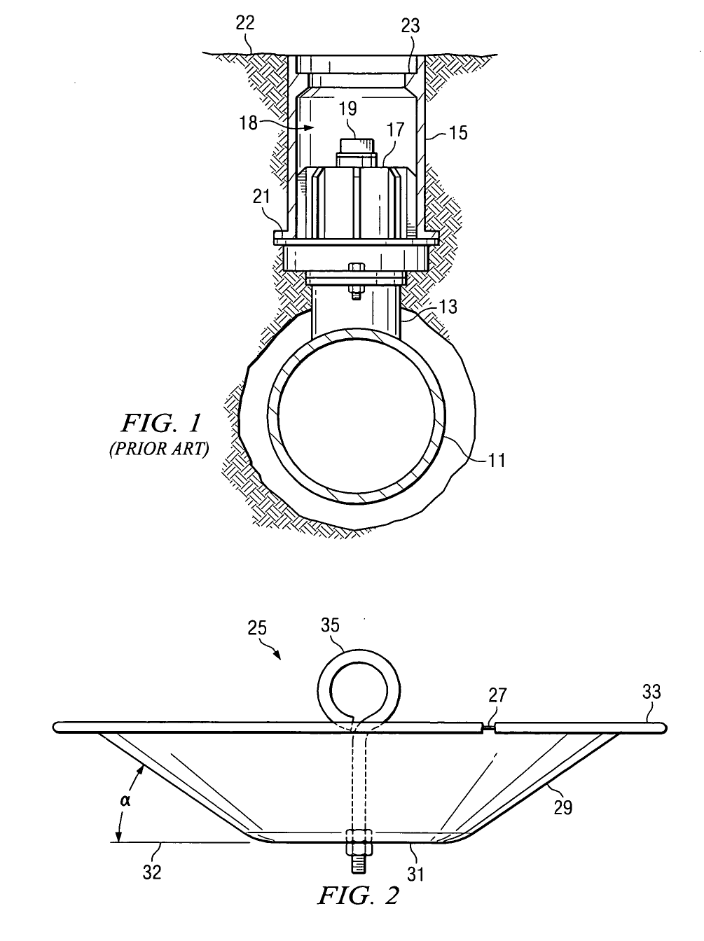

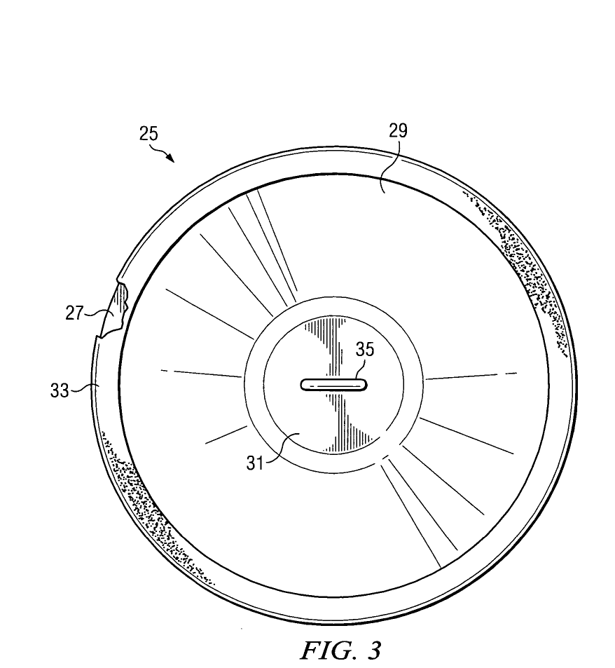

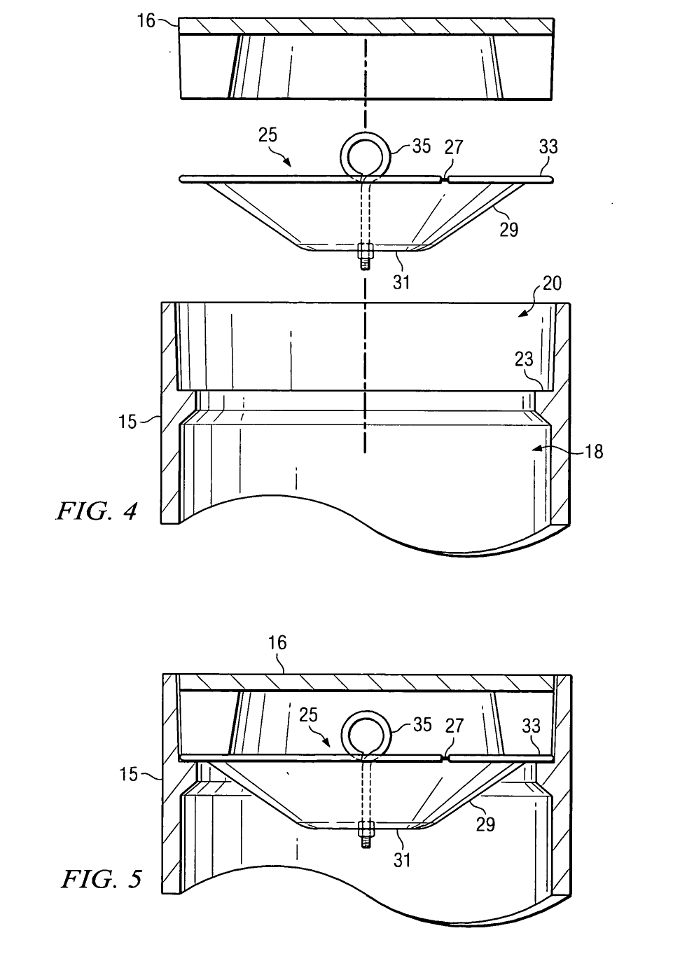

Referring now to FIG. 1 of the drawings, there is shown in pictorial fashion, a typical prior art buried water pipeline 11, valve 13 and valve box or enclosure 15. The valve has a stem 17, at the upper end of which is a square fitting 19. The lower end of the valve box or enclosure 15 may be secured to the valve flange 21, as by welding. The valve box enclosure, as shown, is normally cylindrical and extends to the surface, and the top end is normally closed by a removable cap or cover (16 in FIGS. 4 and 5). The enclosure has an internal shoulder (23 in FIG. 1). The interior is divided into a lower region surrounding the operating end of the valve stem (generally at 18 in FIG. 4) and an upper region (generally at 20 in FIG. 4) extending to a surrounding surface, as viewed in FIG. 1.

As described in the foregoing, frequently the valve box or enclosure 15 becomes filled with silt, dirt, or other debris so that access cannot be readily had to the fitting 19 without the necessity of digging out any accumulated debris within the interior of the valve box. In some cases, a maintenance crew wishing to gain access to the operating fitting of the valve stem may find that the material within the enclosure has become so solidified that it cannot be extricated without a great deal of effort. Even where the material is loose silt, soil or debris, some effort is required to uncover the valve nut, thereby wasting valuable time and labor.

FIG. 2 shows a silt trap 25 of the invention which is intended to be installed within the valve box 15, shown in FIG. 1, to prevent the accumulation of silt and debris within the enclosure. The silt trap 25 is sized to be received within the upper region (20 in FIG. 4) of the circular enclosure on the internal shoulder 23 which is provided as a part of the valve box. As will be appreciated from FIG. 2, the silt trap is formed as a tapered bowl having an upper peripheral lip region 27 and downwardly extending sidewalls 29 which terminate in a generally planar bottom region 31 of the bowl. The angle “α” formed between the horizontal plane 32 of the bottom region of the bowl and the sidewall is approximately 35 degrees in FIG. 2. The silt trap is also provided with a peripheral sealing element 33 which circumscribes the upper peripheral lip region of the bowl and a centrally located handling element 35 which extends upwardly from the bottom region of the bowl.

The tapered bowl can be made of any of a number of convenient materials including various metals and metal alloys and various synthetic plastics. Preferably, the bowl is formed of stainless steel because of its corrosion resistance and relative light weight. The handling element 35 in the embodiment of the invention illustrated is an I-bolt which is centrally mounted for ease of installing and removing the silt trap from within the valve box. The sealing element 33 illustrated in FIG. 2 is preferably a U-shaped elastomeric gasket which surrounds the peripheral lip region 27 of the bowl on an approximate ⅜ inch wide flange. The tapered bowl has a predetermined bowl depth, the bowl depth being in the range from about 1½ to 3 inches in the embodiment of the invention illustrated, so as to not interfere with the operating end of the valve stem 17 in an existing valve box. Preferably, as has been mentioned, the tapered bowl is sized so as to be received within the existing diameter of a 7½ inch cast iron water or gas valve box with the sealing element 33 forming a seal against the surrounding sidewalls of the valve box enclosure.

The method of utilizing the device of the invention will now be briefly described. In the method of the invention, assured access is provided to a valve-operating stem 17, having an operating fitting 19 at an operating end thereof, of an underground valve 13. The valve 13 has a circular enclosure 15, as has been described, with an interior 18 defined by a lower region 18 surrounding the operating end of the valve stem and an upper region 20 extending to a surrounding surface (22 in FIG. 1).

In the first step of the method, a silt trap such as the previously described trap 25 is provided which is sized to be received within the upper region 20 of the circular enclosure 15. The silt trap 25 is installed by using the handling element 35 to lower the trap 25 into position on the internal shoulder 23 provided within the interior 18 of the circular enclosure 15. The upper peripheral lip region 27 of the tapered bowl is appropriately sized so that peripheral sealing element 33 which circumscribes the upper peripheral lip region forms a seal with the interior sidewalls 18 of the circular enclosure.

In the next step of the method of the invention, the silt trap 25 is periodically removed from the enclosure by using the handling element 35 to retrieve the trap from the interior of the enclosure. The trap can then be emptied of any accumulated silt or debris, followed by reinstalling the trap within the interior of the enclosure.

An invention has been provided with several advantages. The trap sidewalls are tapered for several specific purposes. The bowl is tapered so as not to interfere with the existing valve box installation, as has been discussed. The tapered design also directs silt and debris to the center lower portion of the tapered bowl as well as providing added strength to the design so that a light weight metal or metal alloy can be used, in turn reducing costs. The trap is designed to allow silt to settle into the bowl to a depth of about ½ to 3 inches. The sealing element of the design not only forms a silt tight seal when the device is in place within the valve box enclosure, but also prevents additional debris from falling into the interior of the enclosure as the trap is being removed. The trap will work as designed, even if the valve box is filled with water. The trap is simple in design and economical to manufacture.

While the invention has been shown in only one of its forms, it is not thus limited but is susceptible to various changes and modifications without departing from the spirit thereof.

I claim:

1. A method of assuring access to a valve-operating stem, having an operating fitting at an operating end thereof, of an underground valve, the valve having a circular enclosure with an interior defined by a lower region surrounding the operating end of the valve stem and an upper region extending to a surrounding surface, by preventing the enclosure from accumulating silt and debris, the method comprising the steps of:
providing a silt trap sized to be received within the upper region of the circular enclosure, the silt trap being formed as a tapered bowl having an upper peripheral lip region and downwardly extending tapered sidewalls which terminate in a generally planar bottom region of the bowl, the silt trap also having a peripheral sealing element which circumscribes the upper peripheral lip region of the bowl and a centrally located handling element which extends upwardly from the bottom region of the bowl;
installing the silt trap by using the handling element to lower the trap into position on an internal shoulder provided within the interior of the circular enclosure, the upper peripheral lip region of the tapered bowl being appropriately sized so that peripheral sealing element which circumscribes the upper peripheral lip region forms a seal with the interior of the circular enclosure.

2. The method of claim 1, further comprising the steps of:
periodically removing the silt trap from the enclosure by using the handling element to retrieve the trap from the interior of the enclosure;
emptying the trap of any accumulated silt or debris; and
reinstalling the trap within the interior of the enclosure.

3. The method of claim 2, wherein the tapered bowl is formed of stainless steel.

4. The method of claim 3, wherein the handling element is an I-bolt.

5. The method of claim 4, wherein the sealing element is an U-shaped gasket which surrounds the peripheral lip region of the bowl when in place.

6. In combination, a silt trap and a valve box of an underground valve, the valve box having a valve-operating stem with an operating fitting at an operating end thereof, the valve box forming a circular enclosure with an interior defined by a lower region surrounding the operating end of the valve stem and an upper region extending to a surrounding surface, the combination comprising:
a trap body formed as a tapered bowl having an upper peripheral lip region and downwardly extending tapered sidewalls which terminate in a generally planar bottom region of the bowl, the peripheral lip region of the trap body being of a predetermined diameter which is sized to be received on an internal shoulder provided within the upper region of the circular enclosure, the trap body also having a peripheral sealing element which circumscribes the upper peripheral lip region of the bowl and a centrally located handling element which extends upwardly from the bottom region of the bowl;
whereby, when the trap body is installed within the interior of the circular enclosure of the valve box on the internal shoulder provided therein, the peripheral sealing element forms a seal with the interior of the circular enclosure which prevents the enclosure from accumulating silt and debris.

7. The combination of claim 6, wherein the tapered bowl is formed of stainless steel.

8. The combination of claim 7, wherein the handling element is an I-bolt.

9. The combination of claim 8, wherein the sealing element is an U-shaped gasket which surrounds the peripheral lip region of the bowl when in place.

10. The combination of claim 9, wherein the tapered bowl has a predetermined bowl depth, the bowl depth being in the range from 1½ to 3 inches, so as to not interfere with the operating end of the valve stem in an existing valve box.

11. The combination of claim 10, wherein the tapered bowl is sized to be received within the existing diameter of a 7½ inch cast iron water or gas valve box.
